(19) United States
(12) Patent Application Publication
(10) Pub. No.: US 2006/0091629 A1
(43) Pub. Date: May 4, 2006

(54) Lawn trailer converter

(76) Inventor: Edward C. Wiesendanger, Union, MO (US)

Correspondence Address: CHARLES C. MCCLOSKEY, 763 S. NEW BALLAS ROAD STE. 170, ST. LOUIS, MO, 63141, US

(21) Appl. No.: 10/975,249

(22) Filed: Oct. 28, 2004

(51) Int. Cl. B62B 1/00

(52) U.S. Cl. 280/47.131

(57) ABSTRACT

The trailer converter device connects to the tongue of a lawn trailer and allows a person to pull the trailer for light loads. The device has a spine to contact the tongue of a trailer at two points, a foot beneath the spine, a stem, and a handle upon the stem. The stem extends upward and forward at an angle from the spine. The stem attains a comfortable height for a homeowner to grasp the handle and to pull a trailer when the present invention connects to the tongue. The present invention can have a foot in a variety of shapes and use various means to connect to the tongue.

### BACKGROUND OF THE INVENTION

The lawn trailer converter relates generally to lawn equipment, and more specifically to trailers pulled behind mowers and small tractors.

Proven useful on farms, tractors and implements shrank in size for use on lawns and gardens in residential areas. Tractors pull many implements around residences. The implements prepare, seed, fertilize, and water soil for lawns and gardens. Along with implements to manipulate soil and crops, tractors pull trailers. The trailers haul cargo, people, raw materials, landscaping materials, and waste.

In both farm size and lawn size trailers, trailers support and contain cargo but require a tractor to move the trailer. A lawn size trailer has an axle, a frame upon the axle with a tongue, and a body upon the frame. The body contains the cargo and the tongue connects to a hitch upon the tractor, usually upon the rear. The tractor then pulls the trailer about a lawn as needed by the homeowner.

Homeowners though often engage in smaller projects about a lawn. Such projects include tree pruning, rose pruning, leaf raking, and rubbish removal. These smaller projects result in lighter weight and larger volume cargo for hauling. A homeowner can readily place the material in the trailer and likely pull the loaded trailer himself. The lighter weight cargo makes using a tractor wasteful and time consuming.

As fuel and equipment costs have increased, using trailers without tractors on small projects appears desirable to homeowners. At present, homeowners have a separate wheelbarrow for small projects.

### DESCRIPTION OF THE PRIOR ART

Garden tractors and their implements have proliferated across the nation. Homeowners off the farms seek the utility of tractors to care for a residence, particularly the landscaping. Landscaping often includes tasks such as leaf raking, brush removal, and planting. Those tasks often involve lightweight cargo that could be handled by a wheelbarrow, trailer, or cart.

Carts pulled behind lawn size tractors have served homeowners well through the years. John Deere® offers a Utility Cart (model 10S) pulled behind many of its lawn and garden tractors. The Utility Cart connects to the rear hitch with a cotter pin inserted through the tongue. Also Ohio Steel has a dump cart kit in various volumes. The dump cart connects to many lawn tractors of various brands. The dump cart has an overlaid strap with a hole aligned with a hole in the tongue. The strap and tongue then connect to a hitch upon the tractor with a cotter pin. In the present art, the tractor moves the trailer as needed by the homeowner. A homeowner has to fuel and operate a tractor to utilize a trailer, even on a lightweight task. Homeowners may expend effort and time to ready a tractor to pull a comparably small load.

The present invention overcomes the need to operate a tractor to pull a trailer for small loads. The present invention has a handle for pulling a trailer manually by connecting to the tongue of a trailer.

### SUMMARY OF THE INVENTION

Generally, the present invention provides a handle for grasping by one or more hands that connects to an existing tongue upon a garden cart, or trailer. The present invention begins with a spine of sufficient length to contact the tongue at two points. Beneath the spine, depends a foot generally centered upon the spine. The foot contacts the ground and maintains the trailer level. Upon one end, typically away from the trailer, a stem joins the spine. The stem extends upward and forward at an angle from the spine. A handle then joins the stem opposite from the spine. A homeowner can thus grasp the handle to pull a trailer when the present invention connects to the tongue.

There has thus been outlined, rather broadly, the more important features of the invention in order that the detailed description thereof that follows may be better understood and that the present contribution to the art may be better appreciated.

The invention may also include pin and socket connection, and cotter pin and flange connection of the spine to a tongue, a foot of various shapes, and stems and handles of various shapes and configurations. Additional features of the invention will be described hereinafter and which will form the subject matter of the claims attached.

Numerous objects, features and advantages of the present invention will be readily apparent to those of ordinary skill in the art upon a reading of the following detailed description of the presently preferred, but nonetheless illustrative, embodiment of the present invention when taken in conjunction with the accompanying drawings. Before explaining the current embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, the phraseology and terminology employed herein are for the purpose of description and should not be regarded as limiting.

One object of the present invention is to provide a new and improved lawn trailer converter.

Another object is to provide a lawn trailer converter that can be easily and efficiently manufactured and marketed to the consuming public.

Another object is to provide a lawn trailer converter that allows a person to pull a trailer by hand when more expedient than by a tractor.

Another object is to provide a lawn trailer converter that is simple in its use and operation.

Another object is to provide a lawn trailer converter that attaches readily to existing trailer tongues.

Another object is to provide a lawn trailer converter that raises the tongue off the ground to a comfortable pulling height.

These together with other objects of the invention, along with the various features of novelty that characterize the invention, are pointed out with particularity in the claims annexed to and forming a part of this disclosure. For a better understanding of the invention, its operating advantages and the specific objects attained by its uses, reference should be had to the accompanying drawings and descriptive matter in which there is illustrated a preferred embodiment of the invention.

### BRIEF DESCRIPTION OF THE DRAWINGS

FIG. 1 shows an isometric view of the present invention proximate to a typical trailer for a lawn tractor;

FIG. 2 shows a side view of the present invention;

FIG. 3 describes an end view from the handle of the present invention; and,

FIG. 4 describes a sectional view of the foot of the preferred embodiment of the present invention.

The same reference numerals refer to the same parts throughout the various figures.

### DESCRIPTION OF THE PREFERRED EMBODIMENT

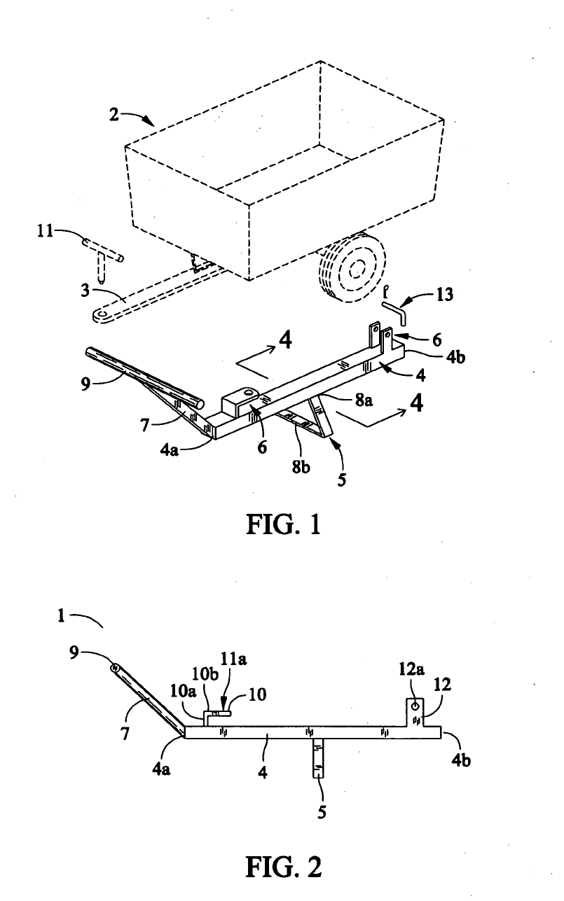

The present art overcomes the prior art limitations by providing a lawn trailer converter that connects to the tongue of an existing cart, or trailer. As a homeowner does a project in the yard, the homeowner may move debris, soil, or plants in a trailer. For lightweight cargo going a short distance, a homeowner may move the trailer himself using the present invention. The present invention 1 converts a trailer 2 from tractor pulled to manually pulled in FIG. 1. A trailer 2 has two wheels upon an axle joined to a frame. A body rests upon the frame and a tongue 3 extends from the frame away from the wheels. The tongue 3 has a rectangular shape in plan and section views. The tongue 3 has a hole in the rounded end opposite the wheels. The present invention 1 slides along the tongue 3 and secures to the hole. A pin 11 from the tractor enters the hole to connect the converter 1 to the tongue 3.

The present invention 1 has a spine 4 of similar width to the tongue 3. The spine 4 secures to the tongue 3 at two points: rear 4b and forward 4a. At the rear 4b of the spine 4, two flanges 12 extend upward from the spine 4 and have coaxial holes to receive a cotter pin. At the front 4a of the spine 4, an angle bracket 10 extends upward from the spine 4 and has a hole 11a away from the corner of the angle bracket 10. In use, a homeowner slides the tongue 3 through the flanges 12 into the angle bracket 10 and then places the tractor pin 11 into the hole 1 and also the hole at the end of the tongue 3. The homeowner then installs a cotter pin 13 between the flanges 12 to secure the spine 4. Generally midway between the securing points 6, a foot 5 depends from the spine 4. The foot 5 makes contact with the ground and raises the tongue 3 to level the trailer 2. The foot 5 also brings the handle 9 to a comfortable height for a homeowner. Upon the end of the spine 4 near the angle bracket 10, a stem 7 extends upward and forward from the spine 4. At the end of the stem 7 opposite the spine 4, a handle 9 joins the stem 7 forming a generally T shape. The handle 9 is perpendicular to the spine 4 and parallel to the face of the trailer body.

To convert a trailer 2 for manual pulling, the present invention 1 appears in section view in FIG. 2. The present invention 1 begins with a spine 4, generally rectangular in shape both lengthwise and in cross section as shown in FIG. 1. The spine 4 has sufficient length to span the distance from the body locking mechanism as in a dump body and the hole in the end of the tongue 3. Generally midway upon the spine 4, a foot 5 descends beneath the spine 4 to support the trailer 2 when using the invention 1. The foot 5 brings the tongue 3 level with the ground surface. Opposite the foot 5, the spine 4 has two securing points 6. The rear securing point has a pair of mutually spaced apart and parallel flanges 12 extending up from the spine 4. The flanges 12 have a generally rectangular shape with coaxial holes 12a opposite the spine 4. As shown in FIG. 1, a cotter pin inserts through the holes 12a to secure the tongue 3 upon the spine 4. The forward securing point has an angle bracket 10, generally L shape, with the long leg 10b of the bracket 10 parallel and offset above the spine 4. The short leg 10a of the bracket 10 welds to the spine 4. Generally centered on the long leg 10b, a hole 11a admits the tractor pin 11 which then engages the hole in the end of the trailer tongue 3. Using the tractor pin 11 at the front securing point 6 and the flanges 12 and pin 13 of the rear securing point 6, the present invention 1 removably connects with a trailer tongue 3.

Upon the forward end 4a of the spine 4 at the forward securing point 6, a stem 7 extends upward and forward of the spine 4, generally at a 45° angle. The stem 7 has a rectangular cross section of slightly less width than the spine 4. The stem 7 in conjunction with the foot 5 raises the handle 9 about twenty to twenty nine inches above the ground. The handle 9 attaches perpendicular to the end of the stem 7 away from the spine 4. For ease of grasping, the handle 9 has a round cross section and alternatively has rubber grips applied to the handle 9.

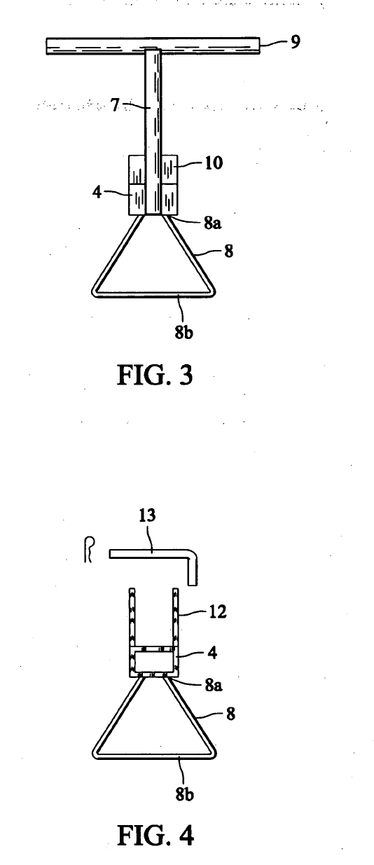

Turning to FIG. 3, the present invention 1 has a foot 5 to support itself and the trailer tongue 3. The foot 5 has a triangular shape 8 formed of bent steel bar and with sides 8b of equal length. A point 8a of the triangle shape attaches the foot 5 to the spine 4 and a side 8b of the triangle contacts the foot 5 with the ground. Above the foot 5, the spine 4 connects to the tongue 3. The spine 4 has a rectangular cross section of slightly larger width than the tongue 3. Here in FIG. 3, the forward end 4a of the present invention 1 has the angle bracket 10 joining to the spine 4. The short leg 10a of the bracket 10 welds to the spine 4 and the long leg 10b extends parallel to the spine 4 and rearward. At the forward end 4a, the stem 7 joins to the center of the spine 4. The stem 7 extends upward from the spine 4 away from the foot 5. Opposite the stem's 7 joint to the spine 4, a handle 9 joins perpendicular to the stem 7. As in FIG. 2, the round cross section handle 9 allows a homeowner to readily grasp the present invention 1 and to pull a trailer 2 with the present invention 1 installed.

Similar to FIG. 3, FIG. 4 shows a section through the foot 5 with the rear securing point in the background. The foot 5 has a generally triangular shape with one side 8b in ground contact and one point 8a joined to the spine 4. The spine 4 has a generally hollow rectangular cross section for strength at light weight. At the spine 4, two sides of the foot 5 come together for welding to the lower corners of the spine 4 cross section. Rearward of the foot 5, two mutually parallel flanges 12 extend perpendicular to the spine 4 and opposite of the foot 5. The flanges 12 are spaced apart for the tongue 3 to fit snugly between them. Once the tongue 3 contacts the spine 4, a homeowner inserts a pin 13 through coaxial holes 12a in the flanges 12 above the tongue 3. The pin 13 has a round head with a cylindrical body centered upon the head and a hole through the body opposite the head and through the diameter of the body. A cotter pin inserts into the hole to secure the pin into the flanges 12 and the tongue 3 within the flanges 12 as the second securing point.

From the aforementioned description, a lawn trailer converter has been described. The lawn trailer converter is uniquely capable of temporarily attaching a pull handle to a light trailer tongue. The lawn trailer converter and its various components may be manufactured from many materials including but not limited to steel, polymers, high density polyethylene HDPE, polyvinyl chloride PVC, nylon, ferrous and non-ferrous metals, their alloys, and composites.

As such, those skilled in the art will appreciate that the conception, upon which this disclosure is based, may readily be utilized as a basis for the designing of other structures, methods and systems for carrying out the several purposes of the present invention. Therefore, the claims include such equivalent constructions insofar as they do not depart from the spirit and the scope of the present invention.

I claim:

1. A device to convert a trailer from towed by a tractor to pulled by hand for light tasks with the tractor including a pin, said device adapted to be attached temporarily to the tongue of the trailer, comprising:
a spine having a forward end away from the trailer and a rear end towards the trailer;
a foot depending from said spine, located proximately to the middle of said spine;
one or more securing means located proximate to one or both ends of said spine and opposite said foot; and,
one or more stems extending outward from the forward end of said spine;
whereby a person places said device upon a trailer and the tongue within said securing means then grasps said handle to move the trailer where desired.

2. The trailer converter device of claim 1 wherein said foot is selected from one of a straight bar, an angle bracket, a rectangle, an arc, or a polygon and joined to said spine.

3. The trailer converter device of claim 1 wherein said foot has a generally triangular shape with one point of the triangular shape joined to said spine and the opposite side from the point in contact with the ground surface.

4. The trailer converter device of claim 1 further comprising:
a handle upon said stem opposite said spine.

5. The trailer converter device of claim 4 wherein said handle is one of a bar, tube, or ring.

6. The trailer converter device of claim 5 further comprising:
said handle being perpendicular to said stem and to the tongue.

7. The trailer converter device of claim 1 further comprising:
said securing means having a location away from said trailer, a bracket, and a pin depending from said bracket;
whereby said pin is located opposite said foot and above said spine, and,
whereby said pin engages a hole at the end of the tongue of the trailer.

8. The trailer converter device of claim 7 wherein said bracket has an L shaped cross section with the short leg perpendicular to said spine and the long leg parallel to said spine and oriented towards the trailer.

9. The trailer converter device of claim 1 further comprising:
said securing means having a location towards the trailer, a pair of mutually parallel and spaced apart planar flanges perpendicular to said spine, said flanges having coaxial holes, and a pin inserted through said holes in said flanges;
whereby said pin is located perpendicular to and above said spine,
whereby said pin passes above and across the tongue of the trailer.

10. The trailer converter device of claim 9 wherein said flanges have a shape selected from one of rectangular, round, ovoid, or polygonal.
